(19) United States
(12) Patent Application Publication
(10) Pub. No.: US 2006/0203279 A1
(43) Pub. Date: Sep. 14, 2006

(54) Image forming apparatus, image forming system, and image forming method

(75) Inventor: Mitsuhiro Kinoshita, Shizuoka-Ken (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Shinagawa-ku (JP)

(21) Appl. No.: 11/255,242

(22) Filed: Oct. 20, 2005

(30) Foreign Application Priority Data
Mar. 14, 2005 (JP) 2005-071214

(51) Int. Cl. G06K 15/00

(52) U.S. Cl. 358/1.14; 358/1.15

(57) ABSTRACT

An image forming apparatus of the present invention includes an image forming unit having a predetermined function to form an image, a control unit for controlling the predetermined function; an operating unit for setting execution of the predetermined function; an identification-information inputting unit for inputting identification information of a user, an authority registering unit in which the predetermined function and identification information of a user having an authority for executing the function are associated with each other and are registered in advance, and a verifying unit for verifying the set predetermined function and the input identification information of the user in accordance with information registered in the authority registering unit. When the verification by the verifying unit succeeds, the control unit executes the predetermined function, and when the verification fails, the control unit does not execute the predetermined function.

### BACKGROUND OF THE INVENTION

1. Field of the Invention

The present invention relates to image forming apparatuses, image forming systems, and image forming methods. In particular, the present invention relates to an image forming apparatus, an image forming system, and an image forming method for inputting documents and images and storing, printing, or displaying them.

2. Description of the Related Art

Today, at companies and so on, in order to address the problems of information sharing and information storage places, digitizing documents printed on paper or the like and storing the resulting electronic documents as image data is becoming common.

Digitizing an enormous volume of print documents and storing the resulting electronic documents on, for example, a certain server in a company allows the information to be shared, so that a person who needs the information can easily access the electronic information whenever necessary. With respect to information that has already been digitized, hard copies thereof can be produced based on the electronic information, whenever necessary. Thus, there is no need to store the source print documents, thus contributing to a reduction in storage space.

However, not all documents are digitized in practice. For example, even today, the so-called “original documents” of tax-related documents, finance-related documents, and so on (hereinafter referred to as “tax/finance-related documents”) are generally stored, at companies and so on, in the form of paper as the original documents without being digitized.

The reason is that, while there are restrictions in terms of a legal system, technology for reading one and only original document while allowing higher reproducibility therefor to be ensured than that for general documents and for printing the read electronic information with high reproducibility is not necessarily sufficient from a technical point of view.

More importantly, conventionally, for image forming apparatuses, such as scanners and so on, technology for ensuring data security, such as confidentiality and falsification protection, has not been sufficiently developed and thus has not put to practical use.

However, in recent years, technologies for higher resolution and higher color reproducibility for image forming apparatuses, such as scanners, are making considerable progress and security technologies for confidentiality improvement, falsification protection, and so on are also making great progress. Thus, from a technological point of view, digitizing the original documents of tax/finance-related documents or the like and storing and maintaining the resulting electronic documents as the electronic master copies can eliminate the need for continuously storing the source original documents in the form of paper.

In order to digitize special documents such as tax/finance-related documents and to store them as electronic master copies, a technology for preventing falsification and a technology for preventing the so-called “impersonation” are essential. Therefore, a technology for attaching digital information, such as digital signatures or timestamps, to the electronic master copies is required.

JP-A 2004-343236 discloses a technology for an image reading apparatus that is capable of verifying an authentic person using the apparatus and that is also capable of preventing impersonation and falsification of read image data.

Digitization of documents, such as tax/finance-related documents, requires a technology for ensuring higher security and higher reproducibility than those for general documents. In particular, the maintainability management or the security management is significantly important for digitizing, maintaining, and managing the tax/finance-related documents.

Accordingly, for example, when a special document such as a tax/finance-related document is digitized to create its electronic master copy, security can be ensured by preventing falsification of the creation date and time and the contents of the created electronic document. This can be achieved by, for example, receiving a timestamp that proves the creation year/month/date/time of the electronic master copy from a third party and embedding the timestamp in the digitized special document.

When an electronic master copy is created, a digital signature affixed by the creator of the electronic master copy is also required to make the source thereof clear. Impersonation and falsification of the electronic master copy are prevented by receiving a certification on the digital signature from a third party.

In order to create the electronic master copy of a tax/finance-related document or the like at a company or the like, a request for the provision of a digital signature or a timestamp is issued to a third party. In many cases, departments that can incorporate the provided digital signature or timestamp into the electronic document are limited to an accounting department or the like in the company.

Conversely, if all employees in the company are permitted to handle the digital signature or timestamp, a considerable cost is required and the digital signature or timestamp may be inappropriately affixed by operation mistake or the like.

Accordingly, it is desired to develop a scheme for permitting only a person or people who have a predetermined authority to affix a digital signature, timestamp, or the like to an electronic master copy.

Other than affixing a digital signature, timestamp, or the like, restricting people who are authorized to use each function, such as a print function or scan function, can also achieve efficient and secure operation of the apparatus in some cases.

### SUMMARY OF THE INVENTION

In view of the foregoing situations, an object of the present invention is to provide an image forming apparatus, an image forming system, and an image forming method which can restrict the affixture of a digital signature, time stamp, or the like to a predetermined authorized user and which can also restrict users who are authorized to use each predetermined function, when reading a special document, such as a tax/finance-related document, to generate its electronic master copy.

In order to overcome the above-described problems, an image forming apparatus of the present invention includes an image forming unit having a predetermined function to form an image, a control unit for controlling the predetermined function; an operating unit for setting execution of the predetermined function; an identification-information inputting unit for inputting identification information of a user, an authority registering unit in which the predetermined function and identification information of a user having an authority for executing the predetermined function are associated with each other and are registered in advance, and a verifying unit for verifying the set predetermined function and the input identification information of the user in accordance with information registered in the authority registering unit. When the verification by the verifying unit succeeds, the control unit executes the predetermined function, and when the verification fails, the control unit does not execute the predetermined function.

An image forming system of the present invention includes an image forming apparatus and a verifying apparatus. The image forming apparatus includes an image forming unit having a predetermined function to form an image, a control unit for controlling the predetermined function, an operating unit for setting execution of the predetermined function, and an identification-information inputting unit for inputting identification information of a user. The verifying apparatus includes an authority registering unit in which the predetermined function and identification information of a user having an authority for executing the function are associated with each other and are registered in advance, and a verifying unit for verifying the set predetermined function and the input identification information of the user in accordance with information registered in the authority registering unit. When the verification by the verifying unit succeeds, the control unit in the image forming apparatus executes the predetermined function, and when the verification fails, the control unit does not execute the predetermined function.

An image forming method of the present invention includes a step of forming an image by using a predetermined function, a step of controlling the predetermined function, a step of setting execution of the predetermined function, a step of inputting identification information of a user, a step of associating the predetermined function with identification information of a user having an authority for executing the function and registering the function and the identification information in advance, and a step of verifying the set predetermined function and the input identification information of the user, in accordance with information registered in the authority registering unit. In the controlling step, the predetermined function is executed when the verification succeeds, and the predetermined function is not executed when the verification fails.

When reading a special document, such as a tax/finance-related document, to generate its electronic master copy, the image forming apparatus, the image forming system, and the image forming method according to the present invention can restrict the affixture of a digital signature, time stamp, or the like to a predetermined authorized users and can also restrict users who are authorized to use each predetermined function.

### BRIEF DESCRIPTION OF THE DRAWINGS

FIG. 1 is a block diagram showing an example of the configuration of an image forming apparatus according to an embodiment of the present invention;

FIG. 2 is a table showing one example of information registered in an authority registering unit in the image forming apparatus according to the embodiment of the present invention;

FIG. 3 is a flow chart showing an example of the operation of the image forming apparatus according to the embodiment of the present invention;

FIGS. 4A and 4B are views each showing an example displayed on an operating unit of the image forming apparatus according to the embodiment of the present invention; and

FIG. 5 is a block diagram showing an image forming system according to another embodiment of the present invention.

### DESCRIPTION OF THE PREFERRED EMBODIMENTS

An image forming apparatus, an image forming system, and an image forming method according to embodiments of the present invention will now be described with reference to the accompanying drawings.

1) Image Forming apparatus of Embodiment

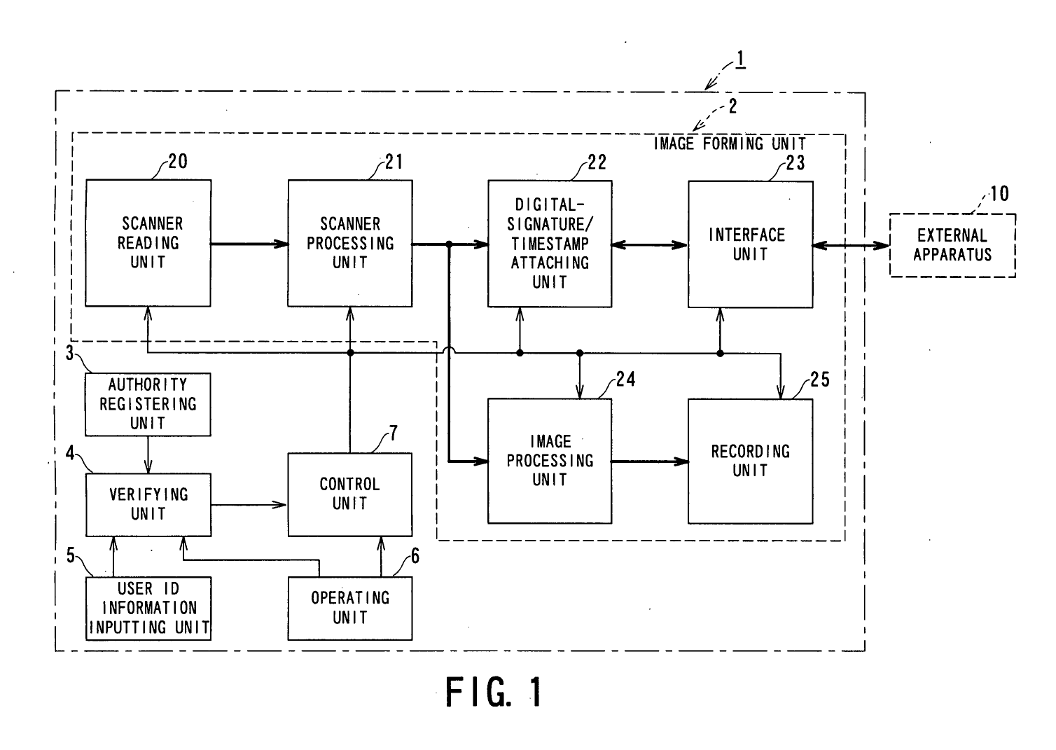

FIG. 1 is an example of the configuration of an image forming apparatus 1 according to an embodiment of the present invention.

An image forming apparatus 1 according to the embodiment of the present invention includes an image forming unit 2, an authority registering unit 3, a verifying unit 4, a user-identification-information inputting unit 5, an operating unit 6, and a control unit 7. The image forming unit 2 has predetermine functions to form an image. The control unit 7 controls the predetermined functions of the image forming unit 2. The operating unit 6 sets the execution of the predetermined functions. The user-identification-information inputting unit 5 inputs the identification information of a user. In the authority registering unit 3, the predetermined functions and the identification information of a user having an authority for executing the functions are associated with each other and are registered in advance. The verifying unit 4 verifies the set predetermined functions and the input user identification information in accordance with information registered in the authority registering unit 3.

The image forming unit 2 is configured so as to achieve a copy function together with a scan function or a print function or in a combination thereof.

More specifically, the image forming unit 2 has a configuration in which a scanner reading unit 20, a scanner processing unit 21, a digital-signature/timestamp attaching unit 22, and an interface unit 23 are sequentially connected. The scanner reading unit 20 optically reads a paper document and converts the read document into image data. The scanner processing unit 21 performs appropriate scanner processing, such as tone correction/conversion, on the image data converted by the scanner reading unit 20. The digital-signature/timestamp attaching unit 22 electronically attaches a digital signature or a timestamp to the image data subjected to the scanner processing. The interface unit 23 communicates with an external apparatus 10.

The image forming unit 2 further includes an image processing unit 24 and a recording unit 25. The image processing unit 24 receives the image data subjected to the scanner processing and performs various types of image processing, such as color conversion processing and filter processing, on the image data. The recording unit 25 prints the image data, subjected to the image processing, on printing paper or the like.

The individual units included in the image forming unit 2 are connected to the control unit 7 and are operated under the control of the control unit 7.

The control unit 7 controls the execution of the predetermined functions set by the user's operation via the operating unit 6. The predetermined functions herein include a scan function, a scan function with a digital-signature/timestamp, a print function, and a copy function.

The scan function is a function for causing the image data, generated by the scanner reading unit 20 and the scanner processing unit 21, to bypass the digital-signature/timestamp attaching unit 22 and then for outputting the image data via the interface unit 23. Alternatively, after the image data is caused to bypass the digital-signature/timestamp attaching unit 22, the image data may be stored in a storage device, such as a HDD, which is not shown.

The scan function with a digital-signature/timestamp is a function for electronically attaching a digital-signature/timestamp to the image data generated by the scanner reading unit 20 and the scanner processing unit 21 and then for outputting the resulting image data via the interface unit 23. Alternatively, after the digital-signature/timestamp is attached, the resulting image data may be stored in the storage device, such as a HDD, which is not shown.

The digital signature is electronic data for certifying the creation source of the electronic master copy and is, for example, electronic information encrypted with an encryption key certified by a third party.

The timestamp is time information containing electronic-master-copy creation year/month/date/time provided by a third party to certify the electronic-master-copy creation year/month/date/time.

The print function is a function for receiving image data from the external apparatus 10, such as a personal computer, causing the image processing unit 24 to perform necessary image processing on the received image data, and then causing the recording unit 25 to perform printing. Instead of receiving image data from the external apparatus 10, image data stored in the storage device, which is not shown, may be printed.

The copy function is a combination of the scan function and the print function, or a function for causing the scan function to convert a paper document into an electronic document and causing the print function to print the image data of the electronic document on appropriate paper or the like.

The user-identification-information inputting unit 5 is means for inputting user identification information. The user identification information is, for example, a user name, a user ID expressed by alphanumeric characters, and a password or the like. While the inputting configuration is not particularly limited, it may be implemented with, for example, a combination of a touch panel and a display unit for displaying alphanumeric characters.

In addition, the user identification information may be biometric information, such as a fingerprint.

The operating unit 6 may have a configuration that allows the setting of various parameters, such as a density setting and the number of prints, in addition to the setting of the functions, such as the scan function. Although the configuration of the operating unit 6 is not particularly limited, it is realized by, for example, a combination of a liquid crystal display and a touch panel.

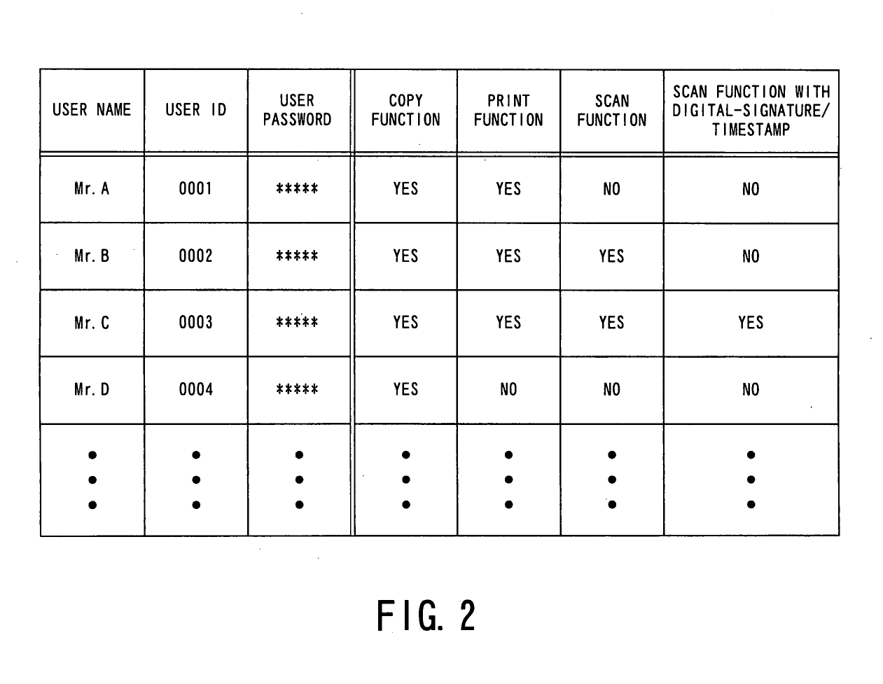

The authority registering unit 3 is means for associating the user identification information with functions permitted to the corresponding user and storing pre-registered information. The authority registering means 3 is implemented with an appropriate semiconductor memory, a HDD, or the like. FIG. 2 shows a specific example of information registered in the authority registering unit 3. The user ID and password of each user and functions permitted to the user are associated with each other and are registered in the authority registering unit 3. In FIG. 2, when authority for executing a permitted function is given, the presence of the authority is indicated by “YES”, and when the authority is not given, the absence of the authority is indicated by “NO”. For example, authority for executing only the copy function and the print function is given to person A. In contrast, authority for executing all of the copy function, the print function, the scan function, and the scan function with a digital-signature/timestamp is given to person C.

The verifying unit 4 compares a function or functions set via the operating unit 6 and the user identification information input via the user-identification-information inputting unit 5 with the information registered in the authority registering unit 3, to thereby determine whether or not the corresponding user has the authority for executing the function(s) set via the operating unit 6. When the user has the authority, it is determined that the verification succeeds, and when the user does not have the authority, it is determined that the verification fails.

The result of the verification is output to the control unit 7 for each function. The control unit 7 controls the individual units of the image forming unit 2 so as to execute only the function(s) for which the verification succeeded.

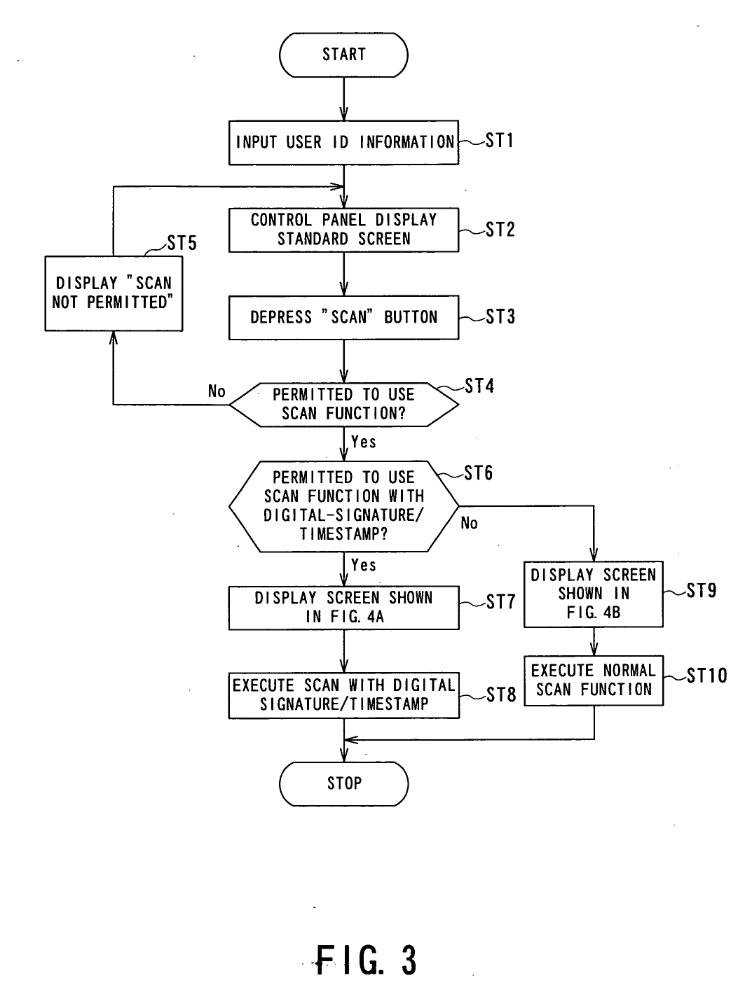

An example of the operation of the image forming apparatus configured as described above will now be described with reference to FIG. 3.

In step ST1, a user enters the user identification information to use the image forming apparatus 1.

In step ST2, a standard screen is displayed on the control panel (the operating unit 6) of the image forming apparatus 1. Buttons corresponding to the basic functions, i.e., “scan”, “print”, and “copy”, are displayed on the standard screen. The control panel (the operating unit 6) includes, for example, a liquid crystal display and a touch panel.

In step ST3, for generating the electronic master copy of a special document, such as a tax/finance-related document, by using the scan function with a digital-signature/timestamp, the user depresses the “scan” button via the touch panel.

In step ST4, the verifying unit 4 determines whether the user is permitted to use the scan function entered (set) via the control panel (the operating unit 6), in accordance with information registered in the authority registering unit 3.

When the user is not permitted to use the scan function, a message indicating “scan not permitted” is displayed on the operating unit 6 in step ST5. Thereafter, the process returns to step ST2.

On the other hand, when it is verified that the user is permitted to use the scan function, in step ST6, the verifying unit 4 further verifies whether or not the user is permitted to use the scan function with a digital-signature/timestamp, in accordance with the information registered in the authority registering unit 3.

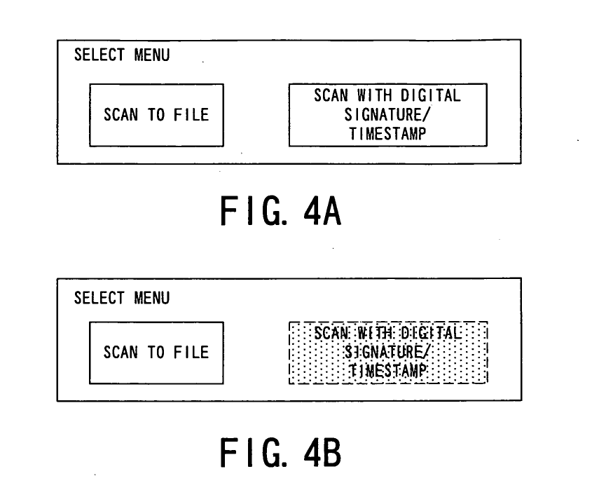

When the user is permitted to use the scan function with a digital-signature/timestamp, a screen illustrated in FIG. 4A is displayed on the control panel (the operating unit 6) in step ST7.

A “scan to file” button and a “scan with digital-signature/timestamp” button are both brightly displayed in FIG. 4A. This display indicates that the user can selectively execute both the normal scan function and the scan function with a digital-signature/timestamp.

In step ST8, for example, by depressing the “scan with digital-signature/timestamp” button via the touch panel, the user can execute the scan function with a digital-signature/timestamp.

On the other hand, when the user is not permitted to use the scan function with a digital-signature/timestamp, a screen illustrated in FIG. 4B is displayed on the control panel (the operating unit 6) in step ST9.

While the “scan to file” button is brightly displayed in FIG. 4B as in FIG. 4A, the “scan with digital-signature/timestamp” button is either not displayed or displayed with low brightness. This display indicates that the user can execute only the normal scan function. In this case, in step ST10, the user depresses the “scan to file” button to execute the scan function.

Since the image forming apparatus 1 according to the present invention has a configuration in which a user and functions permitted to the user are pre-registered and the user is permitted to execute only the function(s) based on the registered information, high security can be ensured.

When creating the electronic document of a special document, such as a tax/finance-related document, by using the scan function with a digital-signature/timestamp, limited users having the authority therefor, for example, only users in an accounting department are generally permitted. The image forming apparatus 1 of the present embodiment can permit only a specific user to use the scan function with a digital-signature/time stamp, and can thus prevent general users to use the function. This can ensure high security, can reduce unwanted cost resulting from the use by general users, and can eliminate losses resulting from wrong operations.

2) Image Forming System of Embodiment

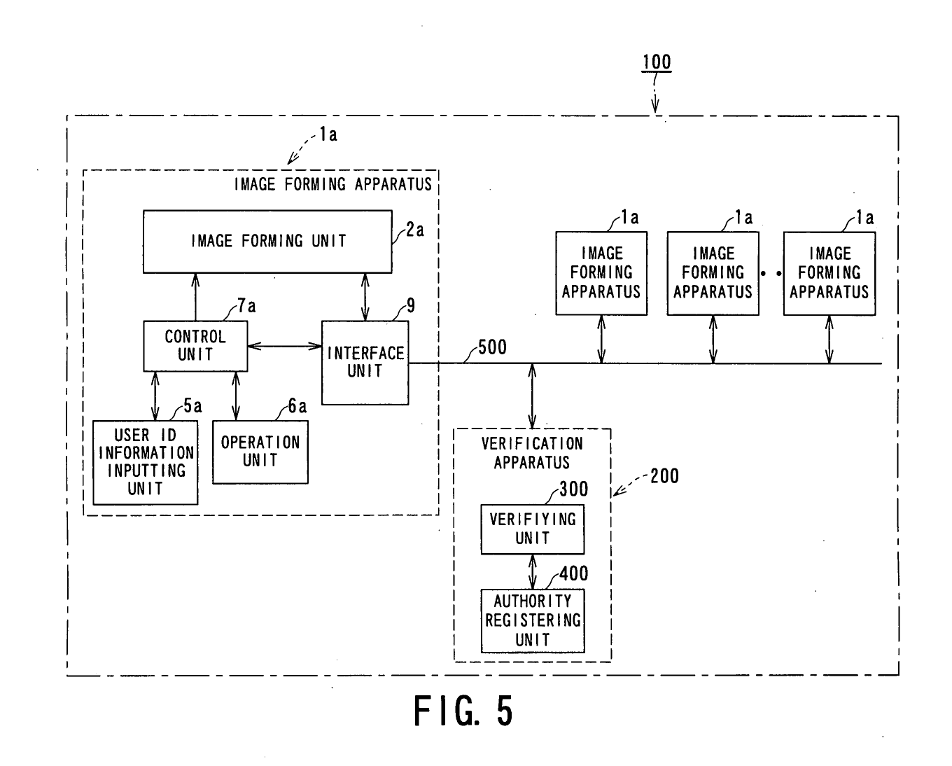

FIG. 5 is an example of the configuration of an image forming system 100 according to an embodiment of the present invention. The image forming system 100 has a configuration in which multiple image forming apparatuses la are connected to a verifying apparatus 200 through a network 500.

The verifying apparatus 200 in the image forming system 100 has a configuration in which the authority registering unit 3 and the verifying unit 4 included in the image forming apparatus 1 shown in FIG. 1 are provided.

The user identification information is input from a user-identification-information inputting unit 5a included in each image forming apparatus la and functions, such as the scan function, are set by an operating unit 6a. The user identification information and those functions are transmitted to a verifying unit 300, included in the verifying apparatus 200, through the network 500.

The verifying unit 300 in the verifying apparatus 200 compares the transmitted user identification information and each function with information registered in the authority registering unit 400 to thereby perform verification.

The result of the verification is fed back to a control unit 7a in the corresponding image forming apparatus 1a through the network 500, so that only a permitted function or functions is executed.

Although the multiple image forming apparatuses 1a are connected to the verifying unit 200 via the network 500 in the configuration shown in FIG. 5, one image forming apparatus 1a may be connected to the verifying apparatus 200.

In addition to the advantages of the single image forming apparatus 1, the image forming system 100 according to the present embodiment allows the information registered in the authority registering unit 400 to be managed in an integrated fashion, based on the configuration in which the verification function is concentrated at the verifying apparatus 200. This arrangement further increases the security and facilitates the maintenance and management of the registered information.

The present invention is not only limited to the particular embodiments described above, and in practice, the elements described above can be modified and embodied without departing from the spirit and scope of the present invention. Some of the elements disclosed in the embodiments can be appropriately combined to achieve various modifications of the present invention. For example, some of the elements disclosed in the embodiments may be eliminated. In addition, the elements in the different embodiments may be appropriately combined.

What is claimed is:

1. An image forming apparatus comprising:
an image forming unit having a predetermined function to form an image;
a control unit for controlling the predetermined function;
an operating unit for setting execution of the predetermined function;
an identification-information inputting unit for inputting identification information of a user;
an authority registering unit in which the predetermined function and identification information of a user having an authority for executing the predetermined function are associated with each other and are registered in advance; and
a verifying unit for verifying the predetermined function and the input identification information of the user, in accordance with information registered in the authority registering unit,
wherein, when the verification by the verifying unit succeeds, the control unit executes the predetermined function, and when the verification fails, the control unit does not execute the predetermined function.

2. The image forming apparatus according to claim 1, wherein the predetermined function comprises a function for scanning a document, generating an electronic document, and electronically attaching at least one of a digital signature and a timestamp to the generated electronic document.

3. The image forming apparatus according to claim 2, wherein the predetermined function further includes at least one of a function for copying a document, a function for scanning a document, and an function for printing a document.

4. The image forming apparatus according to claim 1, wherein the operating unit comprises a touch panel and a display unit that is capable of displaying the predetermined function and that is capable of either not displaying the predetermined function or displaying the predetermined function with low brightness, and wherein, when the predetermined function corresponding to the input identification information of the user is not registered in the authority registering unit, the operating unit does not display the predetermined function or displays the predetermined function with low brightness.

5. An image forming system comprising:
an image forming apparatus including
an image forming unit having a predetermined function to form an image,
a control unit for controlling the predetermined function,
an operating unit for setting execution of the predetermined function, and
an identification-information inputting unit for inputting identification information of a user; and
a verifying apparatus including
an authority registering unit in which the predetermined function and identification information of a user having an authority for executing the predetermined function are associated with each other and are registered in advance, and
a verifying unit for verifying the predetermined function and the input identification information of the user, in accordance with information registered in the authority registering unit,
wherein, when the verification by the verifying unit succeeds, the control unit in the image forming apparatus executes the predetermined function, and when the verification fails, the control unit does not execute the predetermined function.

6. An image forming method comprising the steps of:
forming an image by using a predetermined function;
controlling the predetermined function;
setting execution of the predetermined function;
inputting identification information of a user;
associating the predetermined function with identification information of a user having an authority for executing the function and registering the function and the identification information in advance; and
verifying the set predetermined function and the input identification information of the user, in accordance with information registered in the authority registering unit,
wherein, in the controlling step, the predetermined function is executed when the verification succeeds, and the predetermined function is not executed when the verification fails.

7. The image forming method according to claim 6, wherein the predetermined function comprises a function for scanning a document, generating an electronic document, and electronically attaching at least one of a digital signature and a timestamp to the generated electronic document.

8. The image forming method according to claim 7, wherein the predetermined function further includes at least one of a function for copying a document, a function for scanning a document, and a function for printing a document.

9. The image forming method according to claim 6, wherein, in the step of setting the function, the predetermined function is displayed, is not displayed, or is displayed with low brightness, and wherein, when the predetermined function corresponding to the input identification information of the user is not registered in the authority registering step, the predetermined function is not displayed or is displayed with low brightness.
